(19) United States
(12) Patent Application Publication
(10) Pub. No.: US 2019/0336937 A1
(43) Pub. Date: Nov. 7, 2019

(54) TREATMENTS FOR PERSISTENT ORGANIC POLLUTANTS

(71) Applicant: VIROTEC PTY LTD, Arundel, Queensland (AU)

(72) Inventors: Malcolm William CLARK, Lismore (AU); Daniel BLAIR, Arundel (AU); Brian SHEERAN, Arundel (AU); Gisela BARROS, Arundel (AU)

(21) Appl. No.: 16/466,803

(22) PCT Filed: Dec. 5, 2017
(86) PCT No.: PCT/AU2017/051335

§ 371 Date: Jun. 5, 2019

(30) Foreign Application Priority Data
Dec. 5, 2016 (AU) 2016904988

(51) Int. Cl. B01J 20/08; C02F 1/28; B01J 20/20; B01J 20/28; B01J 20/04; B01J 20/30; B01J 20/284

(52) U.S. Cl. CPC B01J 20/08; C02F 1/28; B01J 20/20; B01J 20/28047; C02F 2101/301; B01J 20/3078; B01J 20/284; C02F 1/281; C02F 1/283; B01J 20/045

(57) ABSTRACT

A blended composition when used for the removal of persistent organic pollutants persistent organic pollutants (POP) such as perfluorooctanesulfonate (PFOS) from water, the blended composition comprising Bauxsol and an additive wherein the additive is selected from activated carbon and an oxidizing agent. Also disclosed is a method of using the blended composition in the treatment of contaminated water.

### TECHNICAL FIELD

The present invention relates to the removal of persistent organic pollutants (POPs) from water.

### BACKGROUND

Persistent organic pollutants (POPs) are organic compounds that are resistant to environmental degradation through chemical, biological, and photolytic processes. Many POPs were, or are currently used as pesticides, solvents, pharmaceuticals, and industrial chemicals. However, not all POPs are anthropogenic and some may arise naturally, for example from volcanoes and various biosynthetic pathways, although these are rare.

Typically, POPs are halogenated (halogen X, is typically Cl, or F,) organic compounds, where because of the high degree of stability in the C—X bond, the POP also exhibits non-reactivity toward hydrolysis and photolytic degradation. However, compounds with a C—X bond also exhibit a high degree of lipid solubility, which allows them to bio-accumulate in fatty tissues. Consequently, the high stability and lipophilic nature of POPs, which generally correlates with halogen content, make poly-halogenated organic compounds of particular concern in the environment with regard to human/animal health. POPs may also exert detrimental environmental effects through their long-range transport, which allows them to rapidly become ubiquitous in the environment, sometimes distal from original source.

POP bioaccumulation is generally associated with the compounds high lipid solubility and ability to accumulate in the fatty tissues of living organisms for long periods of time. Hence, POPs are also classed as PBTs (Persistent, Bio-accumulative and Toxic) or TOMPs (Toxic Organic Micro Pollutants). Persistent chemicals tend to have higher concentrations and are eliminated more slowly. Dietary accumulation or bioaccumulation is another hallmark characteristic of POPs, as POPs move up the food chain, they increase in concentration as they are processed and metabolized in certain tissues of organisms. The natural capacity for animal's gastrointestinal tract to concentrate ingested chemicals, along with the poorly metabolized and hydrophobic nature of POPs makes such compounds highly susceptible to bioaccumulation.

Consequently, in 1995, the United Nations Environment Programme Governing Council investigated POPs identifying twelve POPs known as “the dirty dozen”. However, the Stockholm Convention on Persistent Organic Pollutants in 2001 was established with the intention to eliminate or severely restrict the production of POPs, and expanded POPs to include many polycyclic aromatic hydrocarbons (PAHs), brominated flame-retardants, and other compounds. The Stockholm Convention list covers the following POPs: Aldrin, Chlordane, Dieldrin, Endrin, Heptachlor, Hexachlorobenzene (HCB), Mirex, Toxaphene, Polychlorinated biphenyls (PCBs), Dichlorodiphenyltrichloroethane (DDT), Dioxins Polychlorinated dibenzofurans, Chlordecone, α-Hexachlorocyclohexane (α-HCH) and β-Hexachlorocyclohexane (β-HCH), Hexabromodiphenyl ether (hexaBDE) and heptabromodiphenyl ether (heptaBDE), Lindane (γ-hexachlorocyclohexane), Pentachlorobenzene (PeCB), Tetrabromodiphenyl ether (tetraBDE) and pentabromodiphenyl ether (pentaBDE), Perfluorooctanesulfonic acid (PFOS), Endosulfans, and Hexabromocyclododecane (HBCD).

Treatment of POPs in the Environment

Adsorption

Many types of adsorbents have been considered and used for the removal of POPs. These include but are not limited to, powdered activated carbon, carbon nanotubes, mesoporous carbon nitride commercial resins, polymers, maize straw-derived ash, alumina, chitosan, goethite, silica, montmorillonite, organo-clay, hexadecyltrimethylammonium bromide (HDTMAB), immobilized hollow mesoporous silica spheres, cetyltrimethyl ammonium bromide-modified sorbent, permanently confined micelle arrays (PCMAs) sorbent, and electrospun fibre membranes.

Activated Carbon

Authors have identified four steps in the adsorption mechanism of POPs to activated carbon. Firstly, diffusion in liquid phase followed secondly by mass transfer to solid-phase. Thirdly, the internal diffusion (pore and surface diffusion) inside an adsorbent and attachment on to adsorbent sites. Fourth and finally, are electrostatic and/or hydrophobic interaction(s) that see the even distribution of the orbed phase.

Alumina and Iron Oxide Sorption

Alumina has many sorbtive properties. Typically, this is purely an exchange process, where changes in pH, particularly to higher pHs reduce sorption loadings through changes in surface charge saturation. At pH's greater than the IEP surfaces become progressively more negative and the polar C∂+-hal∂- becomes progressively repelled by the surface. In addition, the ring structures (phenols and biphenols) contained in many POPs, allows a delocalised electron cloud above and below the ring to be electrostatically attracted to positively charged surfaces. Hence, there are several but weak electrostatic bonds that may occur between POP molecules and charged surfaces.

Organo-Clays

In order to enhance the sorptive capacity of some mineral interfaces organic molecules maybe bound to the mineral surfaces. A modified clay material developed has been developed under the trade name MatCARE™. The modified clay is a palygorskite-based material modified with oleylamine.

Compared with Hydraffin CC8*30, an activated carbon, the physico-chemical properties of both adsorbents determined by standard procedures are shown in Table 1.

TABLE 1
a summary of the adsorbent properties

| | | Hydraffin |
|---|---|---|
| Property | MatCARE | CC8*30 |
| Bulk density (kg m⁻³) | 608 | 410 |
| Particle density (kg m⁻³) | 1,677 | — |
| Porosity (%) | 40 | — |
| Pore volume (kg m⁻³) | — | 7.87 Å~10⁻⁴ |
| Particle size | 77.4% between 2,000 | 0.6-2.36 mm |
| | and 1,180 μm | |
| Surface area (m² g⁻¹) | 31.91 | 1,000 |
| Reversible swelling (%) | 2.5 | — |
| Moisture holding capacity (%) | 50.28 | 40.5 |

As can be seen from Table 1, these organo clay materials seem to show improved POP removal compared to activated carbon, often improving sorption for >90% POP removal to >99% removal for the same water.

While pH has a direct impact on the sorption, high ionic strength waters also strongly influences the binding regime. The adsorption of POPs generally decreases with an increase in ionic strength for all four types of cations (Na⁺, K⁺, Mg²⁺, and Ca²⁺), due to the compression of the electrical double layer. Furthermore, the results also indicate that both Ca²⁺ and Mg²⁺ may form bridges with some POPs in solution, whereas other POPs may only be bridged by Ca²⁺ due to the higher covalent nature of Mg. Similarly, the presence of other organic molecules, can also preferentially bind with surface sorption sites and block POP removal.

Consequently, the binding of a POPs with a charged surface is best described by the partitioning co-efficient Kd, which is a common approach for describing solid/solution interactions. The Kd is calculated as follows:

Kd=(MeP/m)/(MeD/V)

Where; MeP and MeD are the blank corrected trace metals activities on the solid and in solution, respectively; V is the volume of solution (L); and m is the mass of sediment (g).

Partitioning coefficients prove to be more sensitive than the fraction of metal in solution and/or adsorbed, as they better represent metal partitioning at the extremes of the range of fractional uptake, i.e. adsorption <10% or >90%. However, Kd is not a true equilibrium coefficient, but rather an empirical term, depending on factors such as pH, temperature, solution composition, and concentration of colloids in the ‘dissolved’ phase, metal speciation, and particle surface heterogeneity. Hence, Kd is a conditional, but is easily implemented within a surface adsorption modelling.

Destructive

Oxadative Destruction

Oxidation technologies (OTs) have been extensively studied for the removal of POPs. With the highly oxidative potential, the generated hydroxyl radicals by OTs generally attack organic molecules through the H-atom abstraction to form water. However, as many POPs contain no hydrogen to be abstracted in environmentally relevant pH conditions, they are thus relatively inert to OTs. In fact, the decomposition resistance of Perfluorinated Chemicals (PFCs) to conventional OTs is evidenced by the use of PFOS as a surfactant to increase the adsorption of organic pollutants on TiO₂ to obtain the accelerated OT effects. Owing to the high decomposition resistance of PFCs, different forms of exogenous energy, such as ultrasonic waves, UV light, or heat, have been introduced to initiate and accelerate the PFC decomposition. For example, persulfate was employed for the oxidative degradation of PFCs, because the generated sulfate radicals have a one-electron reduction potential of 2.3 eV, making persulfate a strong direct electron transfer oxidant. To obtain efficient PFCs decomposition, photolysis, thermolysis, microwaves, electrochemical, or a combination of different forms of exogenous energy were used for generating sulfate radicals. Highly efficient photocatalysts, such as H₃PW₁₂O₄₀ and TiO₂, were also tested for PFC decomposition under UV light irradiation. However, the harsh reaction conditions (e.g. efficient at pH<2 and light k<390 nm) with H₃PW₁₂O₄₀ and TiO₂ were only capable of decomposing some POPs. Although stronger forms of energy, such as direct photolysis, ultrasonic waves, and pyrolysis, can lead to POP decomposition under certain conditions, the decomposition rates are generally low. To minimize the need for energy in wastewater treatments, the exploration of some POP decomposition techniques without intensive energy input is a timely and important task.

Chemical oxidation of POPs involving permanganate (KMnO₄) is efficient, owing to its high reduction potential (E⁰=+1.7 V) and selective oxidizing character for many organic pollutants. Permanganate is a strong oxidizing agent and has been known to react with electron-rich moieties through several reaction pathways, including electron exchange, hydrogen abstraction, and direct oxygen transfer. Because of its comparative stability, ease of handling, relatively low cost, and pH-independent effectiveness, permanganate has been widely used for in situ chemical oxidation to remediate contaminated soil and wastewater.

Thermal

The life cycle stages for the subcritical water decomposition (SCWD) system of some POPs can be grouped into the following major subsystems: 1) Ar gas and Fe metal preparation (the catalysts); 2) heat supply in the SCWD reactor at 350° C. for 6 h. 3) the resultant water for a PFOS contained H₂ and CHF₃ gas emission; 4) solid-liquid separation, F-containing wastewater treatment and solid residual landfill.

Electro-Chemical

However, the conventional destructive treatments via advanced oxidation processes (AOPs) are not applicable for many POP oxidations because of the strong bond energy of C—X halogen bond and the high reduction potential of F and Cl. In addition, most current technologies possess disadvantages such as harsh treatment conditions, high-energy consumption, and difficulty in large-scale application. However, some POPs can be rapidly decomposed and mineralized by electrochemical oxidation (EO) technique, which has many advantages over the other technologies, such as relatively lower energy consumption, milder conditions, higher removal efficiency, and shorter half time.

Sonochemistry

Sonochemistry uses sound waves are used to generate chemical reactions by generating high vapour temperatures that in turn leads to a pyrolysis and chemical combustion. The mechanism works by using an applied ultrasonic field to an aqueous solution, which begins nucleation of cavitation bubbles. These bubbles start expanding towards a radial maximum, where transient bubbles undergo a quasi-adiabatic compression. This adiabatic compression releases energy that is converted into kinetic energy for any trapped molecules. Consequently, high temperatures are generated in the vapour bubbles (average 5000° K), and because the hot vapour collides with the collapsing bubble wall and resultant heat from the vapour is transferred to the bubble wall reaching temperatures of about 800° K. Pyrolysis of hot water vapour within the collapsing bubbles yields H* and OH* radicals that can react with chemicals (e.g. POPs) that are partitioned in the bubble gas-phase and decompose as a result of pyrolysis and combustion reactions. However, typical ultrasonic degradations are carried out in dilute aqueous (<1 μM) solutions.

Microbiological

Bioremediation of chlorinated compounds by anaerobic bacteria in natural groundwater by reductive dehalogenation is an established low cost remediation practice. However many natural environments particularly the vadose zone, or in unsaturated soils is more challenging due to the soil environment being predominantly aerobic with associated high redox potentials. This reduces the activity and therefore the abundance of dehalo-respiring bacteria such that dehalogenation rates are negligible. However, by adding a bio-stimulating solution (typically containing acetates, and lactates) with high viscosity water-soluble polymers such as carrageenan, alginates, and gellan gum to the vadose zone, redox potential may be substantially lowered and reductive dehalogenation rates enhanced. Moreover, such water-soluble polymers carry or immobilize bacterial cells containing dehalo-respiring bacteria, such cultures. However, the direct generation, enrichment of dehalo-respiring bacteria cultures using inocula from a specific site requires long incubation periods and is costly.

### SUMMARY OF INVENTION

Herein described is a blended composition when used for the removal of persistent organic pollutants (POPs) from water, the blended composition comprising Bauxsol and an additive wherein the additive is selected from activated carbon and an oxidizing agent. Without wishing to be bound by theory, it is thought that the Bauxsol minerals are acting as surface sorbers, while the additive is a pore holding agent. Hence, it is postulated that a first of the compounds is acting as a directing agent for the other, such that sorption surfaces are more efficiently used for POP reduction.

In a first aspect, there is provided a blended composition when used for the removal of persistent organic pollutants (POPs) from water, the blended composition comprising Bauxsol and activated carbon.

In an embodiment, the Bauxsol can be activated. The Bauxsol and/or Activated Bauxsol (sometimes referred to as AB) can contain a number of suitable mineral surfaces that allow POPs to be adsorbed onto the surface. Bauxsol and/or Activated Bauxsol and activated carbon can be bought together as a blend that enhances (increases) the sorbtive power and complexity of the system for POP removal from waters.

The explored treatment options discussed in the background section are focussed on a single methodology, active component, or system to affect the removal of POP. Surprisingly, the natural environment does not work on single modes for effective attenuation, treatment, and/or destruction of pollutants.

The mineral complexity of the raw red mud used for manufacture of Bauxsol indicate that the complexity of mineral assemblages has the advantage that different minerals have different affinities for different contaminants (POPs), and have different working ranges across pH and redox gradients, such that when one mineral is no longer effective in contaminant POP removal others are more effective. Consequently, in embodiments, the present invention may broaden the pH and redox gradient range of Bauxsol treatment beyond that of single or simple combinatorial mineral systems of the literature.

The complex mixture available within Bauxsol can have sorptive capacity for many POPs, and electrostatic attraction can remove POPs from the water. The POP can be a fluoro surfactant. In an embodiment, the fluoro surfactant can be selected from one or more of Perfluorooctanesulfonic acid (PFOSA; conjugate base perfluorooctanesulfonate; PFOS) and perfluorooctanoate (PFOA).

The POP can be a chlorinated hydrocarbon. Trichloroethylene (TCE, trichloroethylene) and perchloroethylene (PCE; tetrachloethylene) are toxic chlorinated hydrocarbons. TCE is an effective solvent for a variety of organic materials first produced widely in the 1920s. The first major use was vegetable oils extraction such as soy, coconut, and palm. However, other food industry uses included coffee decaffeination, and hops and spices flavouring extract preparation. It was further used as a dry-cleaning solvent, although tetrachloroethylene was far superior in this role and used from the 1950s. Furthermore, before its toxic properties were recognized, TCE was used as a volatile analgesic and aesthetic from about 1930. However, because of toxicity concerns, trichloroethylene use in the pharmaceutical and food industries was banned from the 1970's in much of the world.

Similarly, perchloroethylene (PCE) is a manufactured chemical compound, which Michael Faraday first synthesized PCE in 1821. PCE was widely used for fabric dry cleaning (aka dry-cleaning fluid) and the degreasing metals. It is also a precursor chemical to manufacture other chemicals, and was used in some consumer products. Other PCE names include, perchloroethylene, perc, and tetrachloroethylene. PCE is a non-flammable liquid at room temperature, but evaporates readily giving a sharp, sweet odour. However, in 1979 these chemicals were found to be in drinking water wells, and subsequently both PCE and TCE were identified as toxic carcinogens, with PCE a Group 2A carcinogens.

The POP can be an insecticide or a herbicide. In an embodiment, the insecticide or herbicide can be selected from one or more of PCBs (Polychlorinatedbiphenyls) including liganded varieties such as DDT (dichlorodiphenyltrichloroethane), DDD (Dichlorodiphenyltrichloroethane), DDE (Dichlorodiphenyldichloroethylene), PCDDs (polychlorinated diphenyl dioxins), and PCDFs (polychlorinated diphenyl furans) and organophosphates such as (Chlorpyrifos), thiocarbamate and dithiocarbamates. Whereas, prominent herbicides include phenoxy and benzoic acid herbicides (e.g. 2,4-D), triazines (e.g., atrazine), ureas (e.g., diuron), and chloroacetanilides (e.g., alachlor).

The geochemistry of most of these biphenlyated rings will have similar interactivity with the Bauxsol blend such as PCDD polychlorinated diphenyl dioxins, and PCDFs polychlorinated diphenyl furans. There are over 200 simple PCBs where H, is substituted for a Cl, without adding other ligands. Of the next important compounds these 200+ simple PCB may form some 100+ PCDD's and PCDF's, hence listing each and every one and providing examples would be impractical here.

Fenamiphos ((RS)—N-[Ethoxy-(3-methyl-4-methylsulfanylphenoxy)phosphoryl] propan-2-amine) Prothiophos (4-bromo-2-chloro-1-[ethoxy(propylsulfanyl) phosphoryl]oxybenzene) are both organophosphorous similar to Chlopyrofos. Both compounds are acetylcholinesterase inhibiting pesticides that are currently approved for use in the EU. They are moderately soluble in water, but have a low volatilities, which based on its chemical properties, do not normally, leach to ground waters. Fenamiphos, Prothiophos and Chlopyrophos are not normally persistent in soil or water systems. However, they are highly toxic to mammals, where it is a neurotoxicant, therefore the organophosphates show moderate to high toxicity to most fauna and flora, hence their widespread agricultural use.

Dieldrin (1aR,2R,2aS,3S,6R,6aR,7S,7aS)-3,4,5,6,9,9-hexachloro-1a,2,2a,3,6,6a,7,7a-octahydro-2,7:3,6-dimethanonaphtho[2,3-b]oxirene and Endrin (1R,2S,3R,6S,7R,8S,9S,11R)-3,4,5,6,13,13-Hexachloro-10-oxapentacyclo[6.3.1.1^{3,6}0^{2.7}0^{9,11}]tridec-4-ene) are both organochlorine insecticides developed in the late 1940's and early 50's, and are both considered as persistent organic pollutants (POPs) like DDT in 2004.

Bauxsol can be capable of binding e.g. PFOS and PFOA, but in some cases not as effectively as activated carbon. A blend of Bauxsol and activated carbon may in some embodiments require a lower dose for the removal of e.g. PFOS and PFOA than each of Bauxsol and activated carbon individually.

The water can be any water including but not limited to pore waters of soils and sediments, wastewaters from industrial plants, ground waters from contaminated sites.

The composition may include from about 1% to about 99% by dry weight of the Bauxsol and from about 99% to about 1% by weight of activated carbon. However, in some embodiments, the composition includes from about 98% to about 50% by dry weight of the Bauxsol and from about 2% to about 50% by weight of activated carbon. In some embodiments, the composition includes from 95% to 70% by dry weight of the Bauxsol and from about 5% to about 30% by weight of activated carbon. In some embodiments, the composition comprises a ratio of about 90% to about 80% by dry weight of the Bauxsol and from about 10% to about 20% by weight of activated carbon. In an embodiment, there is at most about 1, 2, 5, 10, 20, 30, 40 or 50% by weight of activated carbon. In an embodiment, there is at least about 99, 98, 95, 90, 80, 70, 60 or 50% by weight of Bauxsol.

The composition can further comprise an oxidising agent. The oxidising agent can be a solid. The composition comprising the oxidising agent can be provided as a blend that enhances (increases) the destructive power and complexity of the system for POP removal from waters.

The composition may be particulate. The composition may be pelletised. The composition may be particulate. The composition may be pelletised. The size of the particulates may be controlled to determine specific hydraulic conductivities. Typically, pellets are controlled to within a range of from at least about 0.25, 0.5, or 1 mm, to up to about 10, 20, 30, 40 or 50 mm in size. A pelletisation process is described for example in WO2005061408 entitled “Porous particulate material for fluid treatment, cementitious composition and method of manufacture thereof”. The pellets can provide a sufficiently hospitable environment for appropriate bacterial assemblages to develop, that can be bought together such that they enhance (increases) the destructive power and complexity of the system for POP removal from waters.

In some embodiments, electrochemistry can be used to enhance (increase) the sorbtive, and/or destructive power, of the composition for POP removal from waters.

The composition may be brought in contact with a catalyst. Catalyst are typically used because they provide steric orientation and/or reductions in the activation energy to break molecular bonds. The catalyst can be selected from H₃PW₁₂O₄₀, TiO₂, or zero-valent iron, such that photo-oxidation may occur, under appropriate wavelengths and intensities and or thermal decomposition may occur.

The addition of a catalyst may be in the range of from about 1% to 99% by dry weight of the catalyst and from 99% to 1% by weight of POP sorbed Bauxsol/activated-carbon blend. In some embodiments, the catalyst is present in an amount in the range of from about 1% to about 50% by dry weight of the catalyst and from 99% to 50% by weight POP sorbed Bauxsol/activated-carbon blend. In some embodiments, the catalyst is present in an amount in the range of from about 1% to about 30% by dry weight of the catalyst and from 99% to 70% by weight POP sorbed Bauxsol/activated-carbon blend. In some embodiments, the catalyst is present in an amount in the range of from about 1% to about 20% by dry weight of the catalyst and from 99% to 80% by weight POP sorbed Bauxsol/activated-carbon blend. This blend and optionally the pellets as described above, may become a pre-concentration step to remove POPs from treatment solutions such that catalyst additions and photo-oxidation may occur on the smallest possible volume of material.

The composition may be heated to allow thermal degradation. Thermal heating provides sufficient additional energy to the system and provides the activation energy required to initiate molecular bond breaking. Such heating would be >about 20° C., in some embodiments >about 100° C., in some embodiments >about 300° C., in some embodiments >about 1000° C., in some embodiments >about 1500° C. The heating can be such that the composition is subject to a pre-concentration step to remove POPs from treatment solutions such that thermal destruction may occur on the smallest possible volume of material. Such heating may be induced by, but not limited to, microwave heating, sonication, or conventional thermal convection.

The process of thermal decomposition may be accompanied with increased pressure so that thermal destruction can become more efficient. Such pressure increases may be from >0 MPa, to the design limits of an enclosed pressure vessel.

In a second aspect, there is provided a blended composition when used for the removal of persistent organic pollutants (POPs) from water, the blended composition comprising Bauxsol and an oxidising agent.

The description of the features of the first aspect of the invention can apply to the second aspect of the invention unless the context makes clear otherwise.

In an embodiment, the Bauxsol can be activated. The Bauxsol and/or Activated Bauxsol can contain a number of suitable mineral surfaces that allow POPs to be adsorbed onto the surface. Bauxsol and/or Activate Bauxsol and oxidising agent can be bought together as a blend that enhances (increases) the sorbtive power and complexity of the system for POP removal from waters.

Bauxsol can be capable of binding pesticides including herbicides and or insecticides. A blend of Bauxsol and oxidising requires a lower dose for the removal of insecticide than each of Bauxsol and activated carbon individually.

The water can be any water including but not limited to pore waters of soils and sediments, wastewaters from industrial plants, ground waters from contaminated sites.

The oxidising agent is an agent that causes other materials to lose electrons, and become oxidised (i.e., an oxidiser is an electron acceptor). Such oxidising agents may be, but are not limited to peroxides (Mg, Na, H), superoxides, permanganates, chromates, dichromates, hypochlorites, chlorites, chlorates, perchlorates, nitrates, persulfates, and ozone among others. The oxidising agent can be provided as a solid, a liquid or a gas. For example, ozone can be injected as gas.

Bauxsol and from about 99% to about 1% by weight of oxidizing agent. However, in some embodiments, the composition includes from about 98% to about 50% by dry weight of the Bauxsol and from about 2% to about 50% by weight of oxidizing agent. In some embodiments, the composition includes from 95% to 70% by dry weight of the Bauxsol and from about 5% to about 30% by weight of oxidizing agent. In some embodiments, the composition comprises a ratio of about 90% to about 80% by dry weight of the Bauxsol and from about 10% to about 20% by weight of oxidizing agent. In an embodiment, there is at most about 1, 2, 5, 10, 20, 30, 40 or 50% by weight of oxidizing agent. In an embodiment, there is at least about 99, 98, 95, 90, 80, 70, 60 or 50% by weight of Bauxsol.

Treatment for the removal POPs from water systems, including soil-lixiviums (leachates; from here in referred to as water), may be treated in a batch mode. Alternatively, the treatment for the removal POPs from water systems may be a continuous treatment. Methods for the treatment of contaminated waters may be in accordance with those described in the published patent WO/2002/034673. In some embodiments, to obtain the best water treatment results, the Bauxsol blend utilised is prepared just before addition to the water. By “just before” it is meant a few minutes or a few hours before addition to water.

Method

The blended composition can be brought into contact with the water to be treated in a number of ways. The blended composition can be added to the contaminated water in small increments. Each increment added to the water can be the same amount or varied amounts can be incrementally added. A small increment can comprise at most 0.1, 0.2, 0.3, 0.4, 0.5, 0.6, 0.7, 0.8 or 1 g/L. The blend can be agitated in the water to ensure through mixing of it into the water. The agitation can be by any means including mechanical stirring. There can be a reaction or settling period before the addition of the next increment of the blended composition. The interval between the addition of increments can be at least 30, 40, 45, 50 or 60 minutes.

In between the addition of the increments of the blended composition, the water can be sampled to determine whether there is a suitable reduction in POP contamination. A suitable amount of reduction might be to a predetermined level that is known to the person skilled in the art due to local or national regulations, or to a level that is desired for a particular subsequent application of the treated water. Australian and New Zealand Environment Conservation Council (ANZECC) trigger concentrations can be found in e.g. Table 6 of the examples. Also in the Examples are provided some threshold concentrations for the New South Wales (NSW) Environmental Protection Agency (EPA). In some embodiments, the level is POP contamination after treatment is less than about 7.0, 3.0, 2.0, 1.0 or 0.5 μg/L. However, the level depends on the contaminant. For example, where arsenic is the contaminant, the level might be reduced to less than about 0.002 mg. A percentage reduction in contamination of at least about 50, 60, 70, 80, 90 or 99% can be a suitable reduction in POP contaminant.

Once suitable discharge levels are met according to the sampling, the water can be separated from the blended composition. The separation can be by centrifugal forces, decanting or other method. The solids can be allowed to settle before e.g. decanting. The solids can be removed for safe disposal.

A continuous treatment is achieved by the addition of the Bauxsol blend at the predetermined dose rate to the influent water. The predetermined dose rate can be about 0.1, 0.2, 0.3, 0.4, 0.5, 0.6, 0.7, 0.8 or 1 g/L per 1, 2, 3, 4, or 5 hours.

Sufficient contact time between initial contacting of the blended composition and the water must be allowed for to suitably remove contaminants before solid/liquid separation. The contact time can be about 30, 60, 90, 120 or more minutes. The contact time may be initiated by detention tanks or reaction pipe loops. A solid liquid separation can then be undertaken by:
a. settling of solids and decanting treated waters utilising active settling ponds, similar to those used in sewage treatment facilities, of which there are numerous designs; or
b. use of inline centrifuge to remove solids. In line centrifuges often require the use of additional reagents (e.g. flocculants) to generate sufficient efficiencies in the system.

Solids material (sludge) that is drawn off, is likely to require dewatering, most often achieved by centrifuging. In addition, because of the fine nature of the Bauxsol blended composition carry over with the decant liquids for both a and b may occur. In an attempt to remedy this, several settling ponds and or centrifuges can be linked in series.

Should the desired blend for contaminant removal be pelletised, the pellets can be used in a continuous treatment in:
a. Static pellet beds where particles are in constant contact with each other, of which there are numerous designs available.
b. Fluidised beds where particles become separated from each other as the treatment fluid passes by.
c. As enclosed static columns.

Where pellets are used, several short column/beds can be connected together in series. If/when treatment begins to fail, a new fresh column/bed can be placed at the effluent end of treatment, while the column/bed closest to the influent can be removed from the process, and the second bed/column that was in line becomes the new influent point (FIG. 3). By constantly replenishing the effluent end of the treatment system and removing the influent, a column/bed now has the potential of infinite length as a counter current design. FIG. 3 shows four configurations of four columns where there is always one column offline for exchanging media. The first reactor in the series is always the next to go offline. On configuration change, the first column goes offline, the second column becomes the first, the third becomes the second and the newly reloaded (fresh) column becomes the third.

The blended composition can be mixed into a filter bed through which water can be passed. A blend of at least about 80, 70, 60 or 50% acid washed sand can be mixed with about 50, 40, 30 or 20% Bauxsol to establish a filter bed. It is thought that the washed acid washed quartz sand may increase the hydraulic conductivity of the filter, but plays no part in chemical removals. Influent lixivium can be pumped through the filter bed at a rate of about 2.0, 2.5, 2.7 or 3.0 L/hr through the sand filter. A filter residence time of about 10, 18, 20 or 30 minutes with the Bauxsol blend can be used.

Prior to the lixivium waters contacting the blended composition filter, an oxidizing agent such as ozone (O₃) can be injected to the lixivium. The oxidizing agent can be injected at a rate of at least about 100, 110 or 120 mL/L to initiate oxidation of the water as it passes through the filter.

### BRIEF DESCRIPTION OF THE FIGURES

Embodiments of the invention will now be described with reference to the accompanying drawings which are exemplary only and in which:

FIG. 1 is a graph showing the before and after results for a Bauxsol and oxidizing agent (O₃) additions to a pesticide-enriched wastewater.

FIG. 2 is a graph showing the before and after results for a Bauxsol and oxidizing agent (O₃) additions to a pesticide-enriched and metal enriched wastewater.

FIG. 3 shows an example of a counter-current design configurations to generate bed/columns of infinite length.

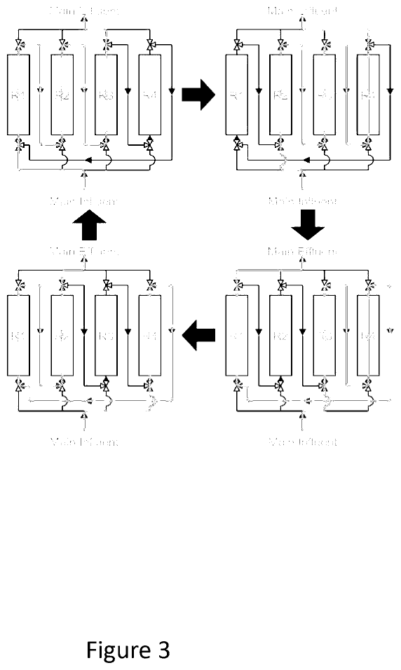

### DETAILED DESCRIPTION OF EMBODIMENTS OF THE INVENTION

Bauxsol is a substance capable of binding metals and neutralising acid. Bauxsol is a substance that may be selected from bauxite refinery residues, known as red mud. Bauxsol may be referred to as a neutralised bauxite refinery residue. Bauxsol can be untreated or have been at least partially reacted with calcium and/or magnesium ions so as to have a reaction pH when mixed with 5 times its weight of water, of less than 10.5; neutralised by addition of acid; neutralised by injection of carbon dioxide; neutralised by addition of other minerals (such as gypsum); neutralised with ferruginous residues from other mineral processing industries (for example the red mud produced during titanium refining, ferruginous soils, ferruginous rock material (such as the fines produced as a by-product of iron ore mining) or bauxite). The Bauxsol material can preferably be finely ground.

Preferably, the Bauxsol substance in the blend capable of binding metals and neutralising acid is red mud from bauxite refinery operations that has been at least partially reacted with calcium and/or magnesium ions so as to have a reaction pH, when mixed with 5 times its weight of water, of less than 10.5.

One method by which the Bauxsol may be prepared is by reacting red mud with calcium and/or magnesium ions as described in International Patent Application WO2004/046064, the contents of which are incorporated herein in their entirety. Another way in which Bauxsol may be prepared is by reaction of red mud with sufficient quantity of seawater to decrease the reaction pH of the red mud to less than 10.5. For example, it has been found that if an untreated red mud has a pH of about 13.5 and an alkalinity of about 20,000 mg/L, the addition of about 5 volumes of world average seawater will reduce the pH to between 9.0 and 9.5 and the alkalinity to about 300 mg/L.

As taught in International Patent Application No. WO2004/046064, a process for reacting red mud with calcium and/or magnesium ions may comprise mixing red mud with an aqueous treating solution containing a base amount and a treating amount of calcium ions and a base amount and a treating amount of magnesium ions, for a time sufficient to bring the reaction pH of the red mud, when one part by weight is mixed with 5 parts by weight of distilled or deionised water, to less than 10.5. The base amounts of calcium and magnesium ions are 8 millimoles and 12 millimoles, respectively, per litre of the total volume of the treating solution and the red mud; the treating amount of calcium ions is at least 25 millimoles per mole of total alkalinity of the red mud expressed as calcium carbonate equivalent alkalinity and the treating amount of magnesium ions is at least 400 millimoles per mole of total alkalinity of the red mud expressed as calcium carbonate equivalent alkalinity. Suitable sources of calcium or magnesium ions include any soluble or partially soluble salts of calcium or magnesium, such as the chlorides, sulfates or nitrates of calcium and magnesium.

A further method by which Bauxsol may be prepared comprises the steps of:
(a) contacting the red mud with a water-soluble salt of an alkaline earth metal, typically calcium or magnesium or a mixture thereof, so as to reduce the pH and alkalinity of the red mud; and
(b) contacting the red mud with an acid so as to reduce the pH of the red mud to less than 10.5.

Optionally, this method may further include the step of separating liquid phase from the red mud after step (a) and before step (b).

In step (a), the pH of the red mud can be reduced to in the range of from about 8.5 to about 10, alternatively to in the range of from about 8.5 to about 9.5, alternatively to in the range of from about 9 to about 10, alternatively to about 9.5 to about 10, preferably from about 9 to about 9.5.

In step (a), the total alkalinity, expressed as calcium carbonate alkalinity, of the red mud may be reduced to be in the range of about 200 mg/L to about 1000 mg/L, alternatively to the range of about 200 mg/L to about 900 mg/L, alternatively to the range of from about 200 mg/L to about 800 mg/L, alternatively to the range of from about 200 mg/L to about 700 mg/L, alternatively to the range of from about 200 mg/L to about 600 mg/L, alternatively to the range of from about 200 mg/L to about 500 mg/L, alternatively to the range of from about 200 mg/L to about 400 mg/L, alternatively to the range of from about 200 mg/L to about 300 mg/L, alternatively to the range of from about 300 mg/L to about 1000 mg/L, alternatively to the range of about 400 mg/L to about 1000 mg/L, alternatively to the range of about 500 mg/L to about 1000 mg/L, alternatively to the range of about 600 mg/L to about 1000 mg/L, alternatively to the range of from about 700 mg/L to about 1000 mg/L, alternatively to the range of about 800 mg/L to about 1000 mg/L, alternatively to the range of about 900 mg/L to about 1000 mg/L, preferably less than about 300 mg/L.

In step (b), the pH is typically reduced to less than about 9.5, preferably to less than about 9.0, and the total alkalinity, expressed as calcium carbonate equivalent alkalinity, is preferably reduced to less than about 200 mg/L.

As described in International Patent Application No WO2004/046064, Bauxsol is a dry red solid that consists of a complex mixture of minerals. The general composition of Bauxsol depends on the composition of the bauxite and operational procedures used at each refinery as well as by how the red mud is treated after production. Neutralisation, of the raw red mud from the bauxite refinery, is achieved when soluble Ca and Mg salts are added and convert soluble hydroxides and carbonates into low solubility mineral precipitates. This procedure lowers the basicity to a pH of about 9.0 and converts most of the soluble alkalinity into solid alkalinity. More specifically, hydroxyl ions in the red mud wastes are largely neutralised by reaction with magnesium in the seawater to form brucite [Mg₃(OH)₆] and hydrotalcite [Mg6Al₂CO₃(OH)₁₆.4H₂O], but some are also consumed in the precipitation of additional boehmite [AlOOH] and gibbsite [Al(OH)₃] and some reacts with calcium in the seawater to form hydrocalumite [Ca₂Al(OH)₇.3H₂O] and p-aluminohydrocalcite [CaAl₂(CO₃)₂(OH)₄0.3H2O]. The average composition of the raw Bauxsol is iron oxy-hydroxide (hematite) 31.6%, aluminium oxy-hydroxides (gibbsite) 17.9%, sodalite 17.3%, quartz 6.8%, cancrinite 6.5%, titanium oxides (anatase) 4.9%, calcium-alumino-hydroxides and hydroxy-carbonates (e.g. hydrocalumite) 4.5%, magnesium-alumino-hydroxides and hydroxy-carbonates (e.g. hydrotalcite) 3.8% calcium carbonate 2.3% halite 2.7%, others (e.g. gypsum) 1.7%. The mineralogy of the Bauxsol material contains abundant Al, Fe, Mg, and Ca hydroxides and carbonates to provide either tobermorite gel constituents for the setting of concretes, or provide appropriate additives to induce early setting of the concrete. Conversely, increased gypsum content within Bauxsol can retard setting rates.

Bauxsol can have a high acid neutralising capacity (2.5-7.5 moles of acid per kg of Bauxsol) and a very high trace metal trapping capacity (greater than 1,000 milliequivalents of metal per kg of Bauxsol); Bauxsol can also have a high capacity to trap and bind phosphate and some other chemical species. Bauxsol can be produced in various forms to suit individual applications (e.g. slurries, powders, pellets, etc.) but all have a near-neutral soil reaction pH (less than 10.5 and more typically between 8.2 and 8.6) despite their high acid neutralising capacity. The soil reaction pH of Bauxsol is sufficiently close to neutral and its TCLP (Toxicity Characteristic Leaching Procedure) values are sufficiently low that it may be transported and used without the need to obtain special permits.

Activated Bauxsol

A process not described in the prior art is the activation of the Bauxsol using sulphuric acid. Activation was first described as a means of neutralising caustic red muds, but can be applied to Bauxsol to produce a solid material with a slightly acid surface chemistry, particularly useful in improving arsenic removals.

The details of preparing activated Bauxsol with the combined acid and heat treatment method are as follows from “H. Genç-Fuhrman et al. Journal of Colloid and Interface Science 271 (2004) 313-320 315”. The powder is refluxed in 20% HCl for 20 min and the liquor is precipitated with ammonia at pH≈8. The precipitate is filtered and washed with deionized water (DIW) three times to remove the soluble compounds. The residue is then dried at 110° C. overnight and calcined in air for 2 h at 500° C. Finally, the Bauxsol is again sieved through a 0.2-mm screen, and stored in a vacuum desiccator until used for the batch sorption experiments. Henceforth, the term activated Bauxsol (AB) is used for the powder produced using the combined acid and heat treatment method. Note that in the combined acid and heat treatment method, all soluble salts are removed, whereas Fe and Al are precipitated as their hydroxides and retained in the residues due to the ammonia precipitation.

A second activation method is only the acid treatment is applied as follows. The initial Bauxsol particles below 0.2-mm are refluxed in 20% HCl for 20 min. The acid slurry is then filtered and the residue washed with DIW to remove residual acid and soluble Fe and Al compounds. Finally, the residue is dried at 40° C., re-sieved through a 0.2-mm screen, and used for the experiments without further treatment. The surface area and the cation exchange capacity (CEC) of the prepared powders are determined using the BET-N2 and ammonium acetate (pH 7) methods are increased.

For the third method, ferric sulfate or aluminum sulfate can be added to Bauxsol and AB as a dry powder. This mixture is later added to the arsenate containing solution. The purpose of the addition of ferric sulfate or aluminum sulfate is to change the sign and/or magnitude of the charge on the surface of the adsorbent particles. The amount of ferric sulfate or aluminum sulfate added is calculated as the amount of ferric sulfate or aluminum sulfate having the same cationic charge as the CEC of the AB or Bauxsol.

Advantages

A particular benefit of using Bauxsol in the compositions and methods of the present invention can be that the soluble salt concentrations, especially sodium concentrations are substantially lower than those in untreated red mud. This effect can be particularly important where the salinity of treated waters to be discharged to environments that are sensitive to sodium or salinity increases, or where salinity of discharge waters to be used as irrigation waters may adversely affect plant growth, have a lower potential impact.

More importantly, a polymineralic system such as Bauxsol has many advantages of single mineral treatments for waters, soils, solid, and liquid industrial wastes. Where a mono-mineralic system is used in there is provided only a single mechanism, or action of pollutant removal. Hence, the range of physico-chemical conditions for pollutant removals are limited both in mechanism and conditions. Hence, for example, when using hydrated lime for the treatment of acid rock drainage, only hydroxide precipitation is possible as the removal mechanism where:

M²⁺+2OH⁻→M(OH)₂, where M²⁺ is and divalent trace-metal.

However, most trace metals also form hydroxide complexes and have very narrow pH ranges where particular M(OH)₂ precipitates are stable. Consequently, at pH 5.5 Cu(OH)₂ is at a solubility minimum from hydroxide precipitation, but elements like Zn, and Mn remain highly soluble. But, at pH 8 where Zn is at a solubility minimum from hydroxide precipitation, Cu is remobilised as Cu(OH)₃⁻, and Mn has still not reached a solubility minimum. Thus, simple mono-mineralic systems are often highly selective in what can be bound, but also the effective treatment range such as pH.

Poly-mineralic pollutant treatment systems, such as Bauxsol, are far more effective in their treatment pollutants, because they offer multiple mechanisms of pollutant removal/treatment, and or when one mineral of the system is out of its effective treatment range (e.g., pH) other minerals in the system become active. For example, in the treatment of trace-metals with Bauxsol, there is a sequential preference of metal removal, but also of mineral selectivity for different metals. Metal removal preferences are, Pb>Cr>Fe>Cu>Zn═Ni>Cd>Co>Mn, whereas mineral preferences (current data are limited to 6 metals Cu, Zn, Ni, Cr, Co and Mn) shows that Mn has no mineral preference, but is rather an oxidative precipitation, Cu is preferentially bound to hematite and hydrotalcite, Zn to hematite and gibbsite, Ni preferentially binds to hydrotalcite, Cr to hematite and sodalite, and Co to hematite and sodalite. Consequently, blending of Bauxsol with other minerals, salts, and other materials can enhance, or improve the range or concentrations of species treated, and/or improve the range of physico-chemical conditions in which is can be used. The addition of a neutral bauxite refinery residue was considered in WO/2002/034673, the contents of which are incorporated by reference.

Generally, it is understood that for some blended compositions used to treat some pollutants, the effects of blending, may be synergistic. This means that the pollutant is removed at a far higher rate than either component can achieve by themselves when summed as parts. However, the reverse is also possible, in that the blending agent is antagonistic and decrease performance, which in such cases these blends are not generally utilised, unless pollutant exclusion is sought, which in some cases is highly desirable.

Furthermore, some pollutant removals by blends may be simply additive between the first component and the blending agent (additive) loadings, that is, the mixture is equivalent to the mass-loading sum between what can be loaded to the first component, and that loaded on the blending agent. In purely additive systems, this may potentially lead to a decrease in overall pollutant removal performance, but often the additive is used to control, generally but not limited to, physico-chemical aspects of the treatment system.

Moreover, with some blends, it is not possible to determine if the treatment result is synergistic or additive, because the pollutants are removed to below the detection limits of current instrumentation. In this case once the detection limit is breached, it is impossible to determine if it is only the blending agent that dominates the pollutant removal, or whether the first component is dominant, or whether both components of the blend are actively supporting each other. In such examples, the pollutant to be removed is either already at very low concentrations close to the detection limit, and/or the pollutants has a very high affinity to either the blending additive and/or the first component, and can be removed to below detection from substantially higher concentrations.

Consequently, the use and choice of additives to be used as blending agents with Bauxsol, the concentration of the blending agent, and the role of the blending agent are not simple choices, nor are they necessarily intuitive and/or obvious to someone skilled in the art of water treatment. As such the application of Bauxsol and or its blends in water treatments must be assessed on a case by case basis and although some general rules apply as to which blends are best suited, the physico-chemical, and chemical makeup of the water can lead to obtuse and counter-intuitive results.

The prior art on Bauxsol as describe does not cover and/or mention the use of Bauxsol in remediation of wastewaters containing POPS, nor the Blending of Bauxsol with activated carbon, or suitable oxidants, to enhance POP removal to Bauxsol products and/or blends. Nor does the prior art investigate or make claims on microbiological activity, photo-, or thermal destruction of organic materials (e.g., POPs).

Substantial literature may be found on the sorptive characteristics of individual minerals such as alumina, hematites, gibbsite, TiO2 towards POPs, however few if any of this literature considers using said minerals in combinations, in the complexity of the mineral assemblages shown by Bauxsol.

### EXAMPLES

Embodiments of the invention will now be exemplified with reference to the following non-limiting examples.

### Example 1

DDT (dichlorodiphenyltrichloroethane) is one of the most well-known synthetic insecticides used in the world. It is a chemical with a long, unique, and controversial history, but like the vast majority of insecticides is based on a chlorinated biphenyl structure, of which there are some 209 congers available from mono substituted 2-Chlorobiphenyl to the fully substituted 2,2′,3,3′,4,4′,5,5′,6,6′-Decachlorobiphenyl. From the biphenyl-system ring hydrogens may also be substituted of additional short chained organic moieties such as ethane as in DDT and DDD (Dichlorodiphenyldichloroethane), or ethylene as in DDE (Dichlorodiphenyldichloroethylene). After WWII, DDT was made widely available for use as an agricultural insecticide, particularly in the control of the malaria mosquito and its production and use soon skyrocketed. In Australia, DDT was used extensively until 1980 as an insecticide in farming, particularly in control of cattle ticks.

Water contaminated with DDT was treated as follows:
1. A blend of 75% Bauxsol and 25% oxidising agent sodium persulfate (Na₂SO₅; a compound derived from the reaction of sodium hydroxide with Caro's acid) was prepared by (37.5 g dry Bauxsol and 12.5 g Sodium persulfate), placing these in a sealed container and agitating the contents until a uniform colour was obtained, indicating that the blend was fully homogenised and dispersed. The blend was used immediately after formation to prevent any long-term degradation of the oxidant.
2. Increments (0.1-0.5 g/L) of the blended composition were added to the treatment water.
3. The blend was agitated for about 15 minutes to endure through mixing.
4. A reaction/settling period (about 45 minutes) was allowed before adding the next increment of Bauxsol blend at 2.
5. The water was sampled to determine its suitability of discharge.
6. Once the DDT concentration fell below about 2.0 μg/L, the water was decanted off after a settling period (8 hours).
7. The solids were removed for safe disposal.

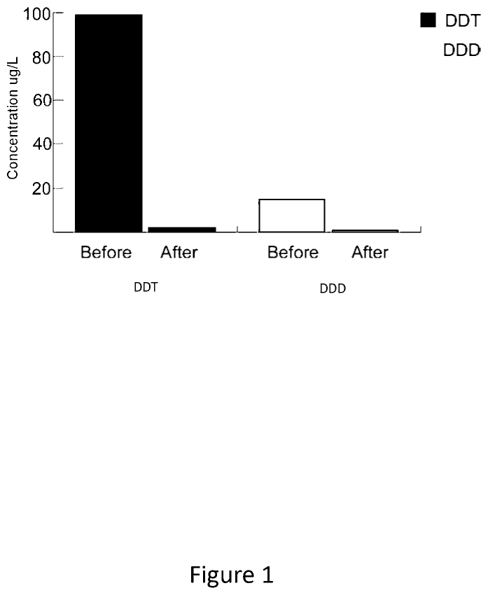

As shown in FIG. 1, in a mixed pesticide-enriched wastewater, DDT was reduced from 99 μg/L to <2.0 μg/L using a combination of an oxidizing agent (O₃) and Bauxsol.

In addition, this treatment successfully demonstrated reductions in the subsequent metabolites of DDT, Dichlorodiphenyldichloroethane (DDD) from 15.2 μg/L to <0.5 μg/L, and Dichlorodiphenyldichloroethylene (DDE) from 1.0 μg/L to <0.5 μg/L (FIG. 1); level of detection for pesticides was 0.5 μg/L.

### Example 2

Chlorpyrifos an organophosphate insecticide, often mixed with toxic trace elements (e Chlorpyrifos (O,O-Diethyl O-3,5,6-trichloropyridin-2-yl phosphorothioate) an organophosphate insecticide, which was introduced by Dow chemicals in 1965 to control foliage- and soil-born insects, particularly on corn, almond citrus, bananas, and apples crops. Chlorpyrifos is often mixed with additional toxic trace elements (e.g., arsenic and zinc), to improve efficacy when used pesticide against resistant pests. A soil matrix contaminated with pesticides, was leached with a MgCl₂ to form an extracted lixivium. Using a blend of chemical reagent additives, Bauxsol and oxidant (O₃) these extracted lixiviums were treated.

Lixivium contaminated with Chlorpyrifos and heavy metals was treated as follows:
1. A blend of 70% acid washed sand and 30% Bauxsol were established as a filter bed, where the washed acid washed quartz sand increases the hydraulic conductivity of the filter, but plays no part in chemical removals.
2. Influent lixivium (60 L in total) was pumped at a rate of 2.7 L/hr through the sand filter that provided a filter residence time of 180 minutes with the Bauxsol.
3. Prior to lixivium waters contacting the Bauxsol filter, an oxidising agent comprising ozone (O₃) was injected to the lixivium at a rate of 100 mL/L to initiate oxidation of the water, which continued as it passed through the Bauxsol and filter.
4. Once the lixivium had passed through the filter, the effluent lixivium, was collected and analysed for Chlorpyrifos, arsenic, and Zn; effluent lixivium had a pH of 8.11.

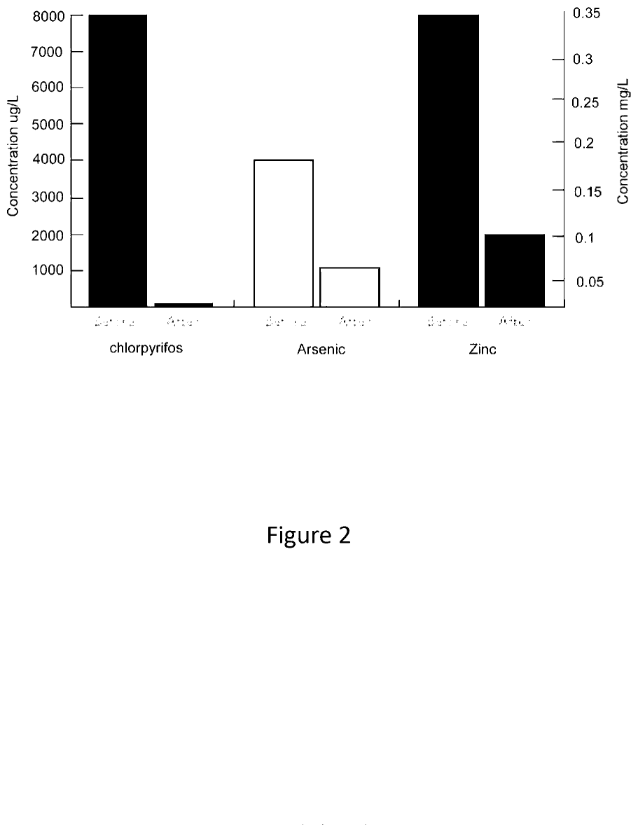

Results in FIG. 2 show that chlorpyrifos was reduced from 7,972 μg/L to 6.4 μg/L, arsenic from 0.13 mg/L to 0.002 mg/L, and zinc from 0.35 mg/L to <0.01 mg/L.

### Example 3

Perfluorooctanesulfonic acid (PFOSA; conjugate base perfluorooctanesulfonate, PFOS) and perfluorooctanoate (PFOA) are anthropogenic fluorosurfactants and global pollutants, added to Annex B of the Stockholm Convention on Persistent Organic Pollutants in May 2009.

PFOS and PFOA concentrations have been detected in wildlife and are considered sufficiently high to affect animal health, and higher PFOS serum concentrations were found associated with increased risk of chronic kidney disease in the general US population. The C8F17 subunit of PFOS is hydrophobic and lipophobic, like other fluorocarbons, while the sulfonic acid/sulfonate group adds polarity. PFOS is an exceptionally stable compound in industrial applications and in the environment because of the effect of aggregate carbon-fluorine bonds. PFOS and PFOA are a fluorosurfactants that lower the water surface tension than that of other hydrocarbon surfactants and has been used extensively as a fire-fighting agent.

PFOS and PFOA contaminated waters were interacted with Activated carbon and Bauxsol and compared. The data showed that Bauxsol was capable of binding substantial PFOS and PFOA, but not as effectively as activated carbon, but that a simple blend of the Bauxsol and activated was possible, which would require a lower dose than each individually.

Method Used
1. Increments (0.1-0.5 g/L) of Bauxsol, and Activated carbon were added to individual 5-L samples of the contaminated treatment water;
2. The blend was agitated for about 15 minutes using a magnetic stirrer to ensure thorough mixing of the solids with the water, before agitation was removed.
3. A reaction/settling period (about 30 minutes) was allowed before adding the next increment of treatment solid; until a total 5 g/L of Bauxsol, and g/L of a 25:75 Activated Carbon were added.
4. The water was decanted off after a settling period (8 hours).
5. The solids were removed for safe disposal.

TABLE 2
PFOS and PFOA removal to an unblended
Bauxsol compared with activated carbon.

| | | Activated | Un-blended | Storm Water |
|---|---|---|---|---|
| | Raw | carbon | Bauxsol | Environmental |
| | water | Treated water | treated water | Discharge Criteria |
| Analyte | (μg/L) | (μg/L) | (μg/L) | (μg/L) |
| PFOS | 6.58 | <0.01 | 3.76 | 0.3 |
| PFOA | 0.217 | <0.01 | 0.15 | 0.3 |
| Sum | 9.57 | <0.01 | | |
| PFOAS | | | | |

### Example 4

1. A blend of 75% Bauxsol and 25% of Activated Carbon blend was prepared by weighing the appropriate components (37.5 g dry Bauxsol and 12.5 g Activated Carbon), placing these in a sealed container and agitating the contents until a uniform colour was obtained, indicating that the blend was fully homogenised and dispersed.
2. Increments (0.1-0.5 g/L) of the blended Bauxsol, and Activated carbon were added to individual one-L samples of the contaminated treatment water.
3. The blend was agitated for about 15 minutes using a magnetic stirrer to ensure through mixing of the solids with the water, before agitation was removed.
4. A reaction/settling period (about 30 minutes) was allowed before adding the next increment of treatment solid as per step 2 above.
5. In total 5 g/L of Bauxsol, 2.5 g/L of activated carbon, and/or 5 g/L of a 25:75 Activated Carbon/Bauxsol blend were added to the individual treatment waters. The determined addition rates could be based on the results of Example 3 above;
6. The water was decanted off after a settling period (8 hours).
7. The solids were removed for safe disposal.

Table 3 shows Perfluoro-sulfonic acid, Perfluoro-acid, and Perfluoroelomer sulfonic acid conger removals from a contaminated water to the Bauxsol 5 g/L, Activated Carbon 2.5 g/L, and a 25% activated carbon 75% Bauxsol blend 5 g/L with 30 min mixing, settled over night, filtered sample 0.45 μg.

The, data shows that the blend is better than either individual component at a higher treatment rate for several POP compounds (e.g., PFOS). However, for some pollutants there appears to be a simple additive process (e.g., PFPeA, PFHxA). Whereas, all remaining chemicals show an indeterminate mechanism because one or both components reduce the raw water concentration below detection, compared to the formulated blend (e.g., 6:2 FTS shows a high degree of affinity for both the Bauxsol mineralogy and the activated carbon), as explained in preceding text.

TABLE 3
the removal of pollutants from contaminated water

| | | | | 25% activated |
|---|---|---|---|---|
| | | | Activated | Carbon: 75% |
| | | Bauxsol | Carbon | Bauxsol |
| | | Treated | Treated | Treated |
| | Raw Water | Water | Water | Water |
| | concen- | concen- | concen- | concen- |
| | tration | tration | tration | tration |
| Analyte | μg/L | μg/L | μg/L | μg/L |
| Perfluorobutane | 0.030 | <0.002 | <0.002 | <0.002 |
| sulfonic acid | | | | |
| (PFBS) | | | | |
| Perfluorohexane | 0.599 | 0.020 | <0.002 | <0.002 |
| sulfonic acid | | | | |
| (PFHxS) | | | | |
| Perfluorooctane | 3.730 | 0.052 | 0.004 | <0.002 |
| sulfonic acid | | | | |
| (PFOS) | | | | |
| Perfluorobutanoic | 0.002 | <0.010 | <0.010 | <0.010 |
| acid (PFBA) | | | | |
| Perfluoropentanoic | 1.720 | 0.025 | 0.012 | 0.010 |
| acid (PFPeA) | | | | |
| Perfluorohexanoic | 0.897 | 0.013 | 0.003 | <0.002 |
| acid (PFHxA) | | | | |
| Perfluoroheptanoic | 0.652 | 0.011 | <0.002 | <0.002 |
| acid (PFHpA) | | | | |
| Perfluorooctanoic | 0.700 | <0.002 | <0.002 | <0.002 |
| acid (PFOA) | | | | |
| 4:2 Fluorotelomer | 0.006 | <0.005 | <0.005 | <0.005 |
| sulfonic acid (4:2 | | | | |
| FTS) | | | | |
| 6:2 Fluorotelomer | 6.460 | 0.018 | <0.005 | <0.005 |
| sulfonic acid (6:2 | | | | |
| FTS) | | | | |
| 8:2 Fluorotelomer | 0.038 | <0.005 | <0.005 | <0.005 |
| sulfonic acid (8:2 | | | | |
| FTS) | | | | |
| 10:2 Fluorotelomer | 0.007 | <0.005 | <0.005 | <0.005 |
| sulfonic acid (10:2 | | | | |
| FTS) | | | | |

### Example 5

A soil matrix contaminated with 3070 mg/kg perchloroethylene PCE, was leached with an ASLP (Australian Standard Leach Procedure, 1997), which is similar to the US TCLP test, to form an extracted lixivium with a PCE concentration 716 mg/L. Using a blend of chemical reagent additives, Bauxsol and oxidant (O₃) these lixiviums were treated. In addition, the soil was also treated using a Bauxsol blend and leached again to determine if in-situ soil treatments can be achieved.

Method Used for PCE Contaminated Soil:
1. A blend of 70% Bauxsol and 25% oxidising agent sodium persulfate (Na₂SO₅; a compound derived from the reaction of sodium hydroxide with Caro's acid) and 5% hydrated lime (Ca(OH)₂) was prepared by (70 g dry Bauxsol and 25 g Sodium persulfate, and 5 g of hydrated lime), placing these in a sealed container and agitating the contents until a uniform colour was obtained, indicating that the blend was fully homogenised and dispersed. The blend was used immediately after formation to prevent any long-term degradation of the oxidant.
2. Soils contaminated with 3070 mg/kg PCE, were treated with the blend at a rate of 10% blend with 90% soil (100 g of Bauxsol blend and 900 g of contaminated soil), where the soil was mixed with the blend in a small mixer until a uniform soil colour developed indicating near homogeneity of the mix.
3. The soil was suspended at a rate of 1 part soil to 5 parts water to form a slurry. Suspension was maintained for about 15 minutes.
4. The soil suspension was allowed to settle and react for 48 hours, before the water was decanted.
5. The soil was allowed to dry, before being sub sampled and leached for total PCE, and ASLP mobile PCE. The post treatment lixivium samples were analysed for their PCE content.

TABLE 4
the reduction in Total and ASLP PCE available in the raw
and treated soils, when treated in the above method.

| | Total PCE | NSW EPA Total | | Allowable |
|---|---|---|---|---|
| | Sample | Allowable PCE | ASLP | concentration |
| | concen- | concentration. | concen- | in the ASLP |
| | tration | (CT2 solid waste) | tration | (CT2 solid waste) |
| Sample | mg/kg | mg/kg | mg/L | mg/L |
| Raw Soil | 3070 | 25.2 | 716 | 0.7 |
| Treated | 3.4 | 25.2 | <0.005 | 0.7 |
| Soil | | | | |

### Example 6

The ASLP lixivium contaminated with PCE (as used in Example 5) from the contaminated soil was treated as if it was a contaminated water as follows:
1. A blend of 70% acid washed sand and 30% Bauxsol was established as a filter bed, where the washed acid washed quartz sand increases the hydraulic conductivity of the filter, but plays no part in chemical removals.
2. Influent lixivium (10 L in total) was pumped at a rate of 2.7 L/hr through the sand filter (700 mL in total volume) that provided a filter residence time of 18 minutes with the Bauxsol;
3. Prior to lixivium waters contacting the Bauxsol filter, ozone (O₃) was injected to the lixivium at a rate of 100 mL/L to initiate oxidation of the water, which continued as it passed through the Bauxsol and filter;

Once the lixivium had passed through the filter, the effluent lixivium, was collected and analysed for PCE, effluent lixivium had a pH of 7.8.

TABLE 5
the contaminated lixivium PCE solution concentrations pre-
and post-ozonation treatment with a Bauxsol filter.

| | Lixivium PCE | ANZECC (1999) Interim |
|---|---|---|
| | concentration | Allowable concentration |
| Sample | μg/L | μg/L |
| Raw Lixivium | 716,000 | 82 |
| Treated Lixivium | <5 | 5 |

### Example 7

A waste water containing several pesticides including herbicides and insecticides was treated. The treatment method was very similar to that used as per Examples 1 and 2.

The treat method was that a waste water contaminated with Chlorpyrifos, DDT, Fenamphos, Prothiophos Dieldrin, Endrin, As, and Zn was treated in the following manner:
1. A blend of 85% Bauxsol 10% activated carbon and 5% oxidising agent sodium persulfate (Na₂SO₅; a compound derived from the reaction of sodium hydroxide with Caro's acid) was prepared by (42.5 g dry Bauxsol, 5 g of activated carbon and 2.5 g Sodium persulfate), placing these in a sealed container and agitating the contents until a uniform colour was obtained, indicating that the blend was fully homogenised and dispersed. The blend was used immediately after formation to prevent any long-term degradation of the oxidant.
2. Increments (0.1-0.2 g/L) of the blended composition were added to the treatment water (10 L).
3. The blend was agitated for about 15 minutes to ensure thorough mixing.
4. A reaction/settling period (about 45 minutes) was allowed before adding the next increment of Bauxsol blend at 2.
5. Once 2. g/L of the blend was added, the water was decanted off after a settling period (8 hours);
6. The solids were removed for safe disposal.

TABLE 6
the effect of the described blend on the removal of
a mixed waste water containing both pesticides (insecticides
and herbicides) and trace element Zn and As.

| | ANZECC trigger value | | |
|---|---|---|---|
| | for 99% protection of | Concentration | Concentration |
| | aquatic ecosystems | In waste water | after treatment |
| Contaminant | μg/L | μg/L | μg/L |
| Arsenic | 15 | 1790 | <1 |
| Zinc | 50 | 415 | 6 |
| Chlopyrophos | 0.009 | 0.188 | <0.005 |
| DDT | 0.0004 | 0.197 | <0.001 |
| Fenamphos | 0.1 | 5.4 | <0.05 |
| Prothiophos | 0.1 | 0.32 | <0.05 |
| Dieldrin | 0.001 | 0.176 | <0.001 |
| Endrin | 0.0008 | 0.174 | <0.001 |

Standard Paragraphs

It is to be understood that, if any prior art publication is referred to herein, such reference does not constitute an admission that the publication forms a part of the common general knowledge in the art, in Australia or any other country.

It is to be understood that in any document incorporated herein by reference, the present description will take preference if there is any information in the incorporated document that is contrary to information described in the present specification

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A blended composition when used for the removal of persistent organic pollutants (POPs) from water, the blended composition comprising Bauxsol and activated carbon.

2. The blended composition of claim 1, wherein the POP is a fluoro surfactant.

3. The composition of claim 2, wherein the fluoro surfactant is selected from one or more of perfluorooctanesulfonic acid (PFOSA; conjugate base perfluorooctanesulfonate; PFOS) and perfluorooctanoate (PFOA).

4. The blended composition of claim 1, wherein the composition comprises about 1% to about 99% by dry weight of the Bauxsol and from about 99% to about 1% by weight of activated carbon; or 98% to about 50% by dry weight of the Bauxsol and from about 2% to about 50% by weight of activated carbon; or 95% to 70% by dry weight of the Bauxsol and from about 5% to about 30% by weight of activated carbon; or 90% to about 80% by dry weight of the Bauxsol and from about 10% to about 20% by weight of activated carbon.

5. The blended composition of claim 1, further comprising an oxidising agent.

6. A blended composition when used for the removal of persistent organic pollutants (POPs) from water, the composition comprising Bauxsol and an oxidising agent.

7. The blended composition of claim 6, wherein the POP is an insecticide.

8. The blended composition of claim 7, wherein the insecticide is selected from one or more of DDT (dichlorodiphenyltrichloroethane), Dichlorodiphenyldichloroethylene (DDE) and Chlorpyrifos.

9. The blended composition of claim 5, wherein the oxidising agent is selected from one or more of peroxides (Mg, Na, H), superoxides, permangenates, chromates, dichromates, hypochlorites, chlorites, chlorates, perchlorates, nitrates, persulfates, and ozone.

10. The blended composition of claim 5, wherein the composition comprises about 1% to about 99% by dry weight of the Bauxsol and from about 99% to about 1% by weight of oxidizing agent; or 98% to about 50% by dry weight of the Bauxsol and from about 2% to about 50% by weight of oxidizing agent; or 95% to 70% by dry weight of the Bauxsol and from about 5% to about 30% by weight of oxidizing agent; or 90% to about 80% by dry weight of the Bauxsol and from about 10% to about 20% by weight of oxidizing agent.

11. The blended composition of claim 5, wherein the oxidising agent is a solid.

12. The blended composition of claim 1, wherein the Bauxsol is activated Bauxsol.

13. The blended composition of claim 1, wherein the water is pore water of soils and sediments, wastewater from an industrial plants or ground water from a contaminated sites.

14. The blended composition of claim 1, wherein the composition is particulate.

15. The blended composition of claim 14, wherein the composition is pelletised.

16. The blended composition of claim 1, wherein the composition is brought into contact with a catalyst selected from H₃PW₁₂O₄₀, TiO₂, or zero-valent iron.

17. The blended composition of claim 16, wherein catalyst is present in the range of from about 1% to 99% by dry weight of the catalyst and from 99% to 1% by weight of POP sorbed Bauxsol/activated-carbon blend; or about 1% to about 50% by dry weight of the catalyst and from 99% to 50% by weight POP sorbed Bauxsol/activated-carbon blend; or about 1% to about 30% by dry weight of the catalyst and from 99% to 70% by weight POP sorbed Bauxsol/activated-carbon blend; or about 1% to about 20% by dry weight of the catalyst and from 99% to 80% by weight POP sorbed Bauxsol/activated-carbon blend.

18.-20. (canceled)

21. The blended composition of claim 5, wherein the water is pore water of soils and sediments, wastewater from an industrial plants, or ground water from a contaminated sites.

22. The blended composition of claim 5, wherein the composition is particulate.

23. The blended composition of claim 5, wherein the composition is brought into contact with a catalyst selected from H₃PW₁₂O₄₀, TiO₂, or zero-valent iron.
